(19) United States
(12) Patent Application Publication
(10) Pub. No.: US 2011/0026177 A1
(43) Pub. Date: Feb. 3, 2011

(54) USING A PASSIVE FUSE AS A CURRENT SENSE ELEMENT IN AN ELECTRONIC FUSE CIRCUIT

(76) Inventors: Prasad R. Atluri, Houston, TX (US); Francisco R. Ramirez, Houston, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/935,136

(22) PCT Filed: Mar. 31, 2008
(86) PCT No.: PCT/US08/58947

§ 371 Date: Sep. 28, 2010

(51) Int. Cl. H02H 9/04

(52) U.S. Cl. 361/56

(57) ABSTRACT

A system comprising a transistor, a passive fuse coupled to the transistor, and control logic coupled to both the transistor and the passive fuse. The control logic determines the current flowing through the passive fuse, by sensing the voltage drop across the passive fuse, and the sends a signal to the transistor to turn off if the current through the passive fuse exceeds a predetermined value.

### BACKGROUND

Passive fuses are traditionally used for isolating fault currents in electrical and electronic circuits. A fuse is a fusible link device which contains a metal wire or strip that melts whenever too much current flows through it. Thus, a gap occurs causing the circuit of which it is apart to open, protecting the rest of the circuit from receiving too much current which can cause damage to the circuit.

Electronic fuse circuits have the same function as a traditional fuse, protecting the rest of a circuit from excessive current, without relying on the fusible link melting. Electronic fuse circuits contain a controller that turns off a field effect transistor, when current is excessive. This turning off of the transistor stops the flow of current through the rest of the circuit; thus, preventing damage from the excessive current flow.

Typically, a resistor is used to sense the current flowing through the transistor. The controller then determines whether the current sensed by this resistor exceeds a predetermined limit. If the current is above the predetermined limit, the controller turns off the transistor. Other current sensing methods use voltage drop across the transistor or the voltage drop across an output filter inductor to determine the amount of current flowing through the transistor. A passive fuse is utilized in the electronic fuse circuit as a backup to prevent excessive current from damaging the remainder of the circuit if the electronic fuse circuit fails for any reason. However, the use of a resistor or any other method described above to sense the current flowing through the transistor increases the size as well as the cost of the electronic fuse circuit. Thus, it would be desirable to design a system which eliminates the need to use a resistor as the current sense element in an electronic fuse circuit.

### BRIEF DESCRIPTION OF THE DRAWINGS

For a detailed description of exemplary embodiments of the invention, reference will now be made to the accompanying drawings in which:

FIG. 1 shows an exemplary embodiment of a circuit system in accordance with embodiments of the invention;

FIG. 2 shows an exemplary embodiment of an electronic fuse circuit currently used in industry;

FIG. 3 shows an exemplary embodiment of an electronic fuse circuit in accordance with embodiments of the invention; and

FIG. 4 shows an exemplary flow diagram of a method implemented in accordance with embodiments of the invention.

### NOTATION AND NOMENCLATURE

Certain terms are used throughout following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

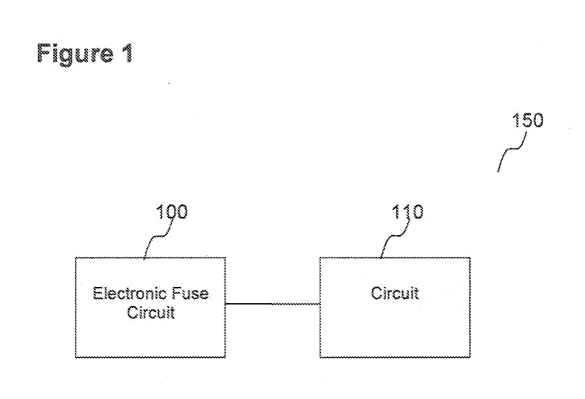

FIG. 1 shows a circuit system 150 in accordance with embodiments of the invention. Circuit system 150 includes electronic fuse circuit 100 which is coupled to logic circuit 110. Logic circuit 110 may be any circuit which may be adversely affected by excessive current. Although only one logic circuit is shown as coupled to electronic fuse circuit 100 in FIG. 1, more than one logic circuit may be coupled to electronic fuse circuit 100 as well. Power is sent through electronic fuse circuit 100 prior to entering logic circuit 110. Electronic fuse circuit 100 is designed to cut off current to logic circuit 110 should the current flowing through electronic fuse circuit 100 become excessive by, for example, a short circuit.

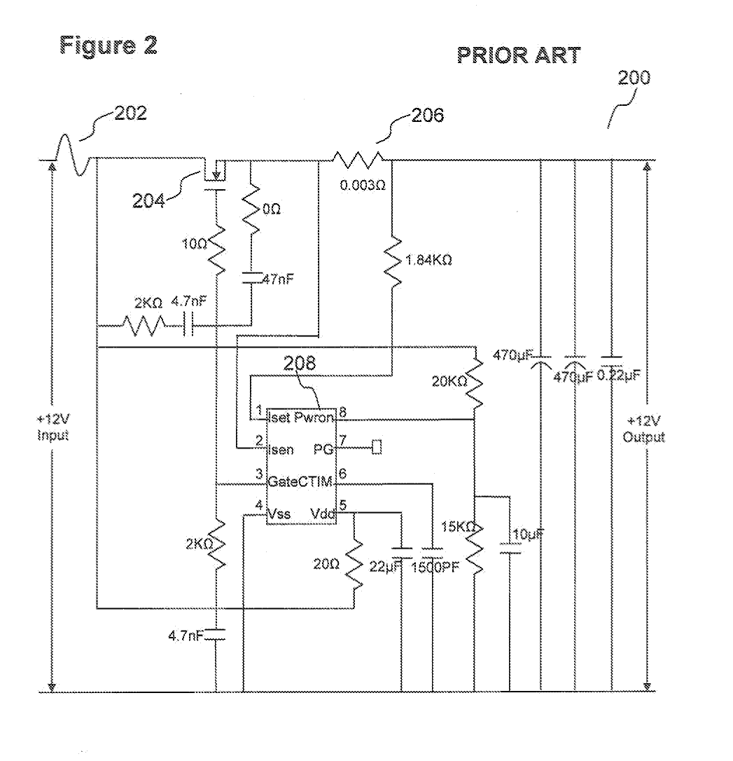

FIG. 2 shows an exemplary embodiment of an electronic fuse circuit 200 currently used in industry. Electronic fuse circuit 200 includes a passive fuse 202, a metal-oxide-semiconductor field-effect transistor (“MOSFET”) 204, a current sense resistor 206, and a controller 208. When turned on, MOSFET 204 allows current to flow through electronic fuse circuit 200; however, if MOSFET 204 is turned off, current is prevented from flowing through electronic fuse circuit 200. Passive fuse 202 is used as a backup to prevent excessive current from damaging the remainder of the circuit (preventing fire or any other hazardous conditions) should electronic fuse circuit 200 fail for any reason.

Controller 208 is coupled to both current sense resistor 206 and MOSFET 204. The current sensed by current sense resistor 206 is determined by controller 208. This is accomplished due to the fact that current sense resistor 206 is connected to pins 1 and 2 on controller 208. These pins monitor the voltage drop across current sense resistor 206 which varies with the current flowing through current sense resistor 206. Controller 208 determines whether the current flowing through current sense resistor 206 is above a predetermined threshold value. If controller 208 determines the current sensed is above the threshold value, controller 208 sends a signal to the gate of MOSFET 204 to turn off MOSFET 204. However, if controller 208 determines the current sensed is below the threshold value, controller 208 does not turn off MOSFET 204 and continues monitoring the current through current sense resistor 206.

If electronic fuse circuit 200 fails for any reason to turn off MOSFET 204 when excessive current runs through it, fuse 202 is used as a backup. Fuse 202 contains a fusible link, usually a metal wire or strip, which melts whenever excessive current flows through it preventing current from flowing through the rest of electronic fuse circuit 200. Thus, electronic fuse circuit 200 (currently in use in industry) contains both a current sense resistor 206 and a fuse 202 to prevent excessive current from flowing through the circuit.

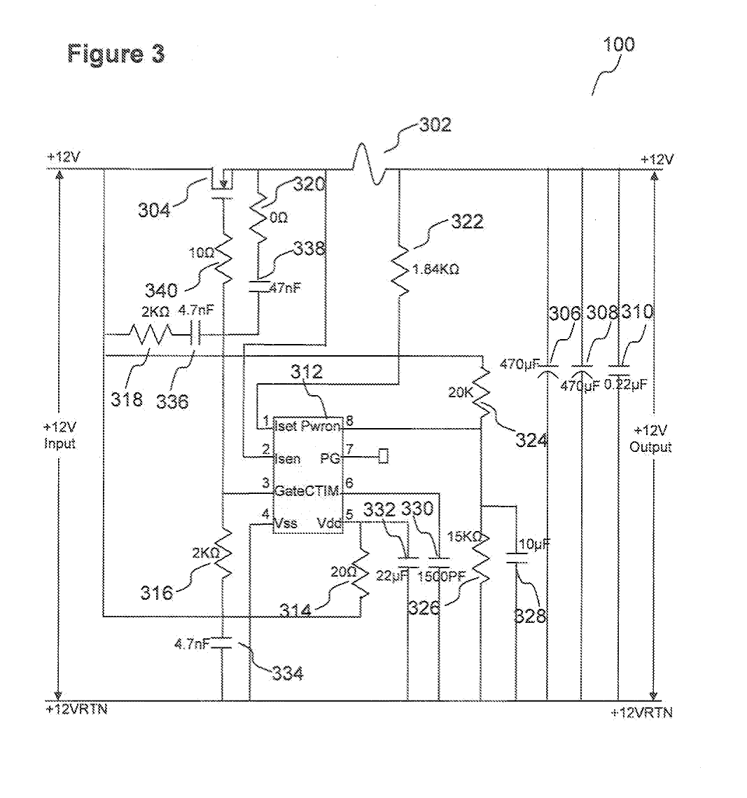

FIG. 3 shows an exemplary embodiment of electronic fuse circuit 100 in accordance with embodiments of the invention. Electronic fuse circuit 100 includes fuse 302; metal-oxide-semiconductor field-effect transistor 304; output filter capacitors 306, 308, and 310, controller 312; resistors 314, 316, 318, 320, 322, 324, 326, and 340 associated with controller 312; and capacitors 328, 330, 332, 334, 336, and 338 associated with controller 312. As stated above, electronic fuse circuit 100 is designed to cut off current to other circuits (e.g., circuit 110 from FIG. 1) which might be coupled with it should current become excessive.

When turned on, MOSFET 304 allows current to flow through electronic fuse circuit 100. While shown as an N-channel MOSFET, MOSFET 304 may be any type of field effect transistor (FET). When MOSFET 304 is turned off, current does not flow through electronic fuse circuit 100 to logic circuit 110. FIG. 3 shows a 12 volt input to electronic fuse circuit 100. When MOSFET 304 is on, then a 12 volt output (less the voltage drop across MOSFET 304 and fuse 302) to logic circuit 110 occurs. However, if MOSFET 304 is turned off, no output voltage will be present and applied to logic circuit 110 due to the fact that no current would conduct through MOSFET 304. Although a 12 volt input corresponding to a 12 volt output is illustrated in FIG. 3, alternative input and output voltages may be used.

Fuse 302 is a passive fuse coupled to MOSFET 304 and is used as a current sense element to sense the current through MOSFET 304. Fuse 302 may be any type of passive fuse available or later developed. For example, a Cooper Bussmann CC12M20A, 20 amp/32 volt passive fuse would work well for a circuit system 150 requiring a 10-15 amp current. Because fuse 302 carries some resistance, approximately 2 milli Ohms for the CC12M20A, fuse 302 is capable of sensing the, current running through MOSFET 304.

Controller 312 is coupled to both fuse 302 and MOSFET 304. For example, an Intersil P/N ISL6115 controller would work well as controller 312; however, other controllers may work as well. The current flowing through fuse 302 is sensed as a voltage drop across fuse 302 and is monitored by controller 312. This is accomplished due to the fact that fuse 302 is connected to pins 1 and 2 on controller 312. These pins monitor the voltage drop across fuse 302 which varies with the current flowing through fuse 302. Controller 312 determines whether the current flowing through fuse 302 is above a predetermined threshold value. A 12 amp threshold value is one threshold value that may be used; however, any current threshold value may be used. This predetermined value is at a level lower than the current level which would damage logic circuit 110; thus preventing damage to logic circuit 110. If controller 312 determines the current sensed is above the threshold value, controller 312 sends a signal to the gate of MOSFET 304 to turn off MOSFET 304. This stops current from flowing through electronic fuse circuit 100 and into logic circuit 110. However, if controller 312 determines the current sensed is below the threshold value, controller 312 does not turn off MOSFET 304 and continues monitoring the current through fuse 302. Hence, MOSFET 304 remains on with the current flowing through electronic fuse circuit 100 and into logic circuit 110.

Fuse 302 also acts as a backup to prevent excessive current from damaging the logic circuit 110 if electronic fuse circuit 100 fails for any reason to turn off MOSFET 304 when excessive current runs through it. Fuse 302 contains a fusible link, usually a metal wire or strip, which melts whenever excessive current flows through it. Thus, electronic fuse circuit 100 cannot send excessive current to logic circuit 110 or any other device coupled to electronic fuse circuit 100. Because fuse 302 acts as both a current sense element and as a backup fuse, a separate current sense which might otherwise be included is eliminated. Thus, the size and cost of electronic fuse circuit 100 is reduced. Also, the power dissipation associated with the use of a separate current sense resistor is eliminated which increases the efficiency of electronic fuse circuit 100.

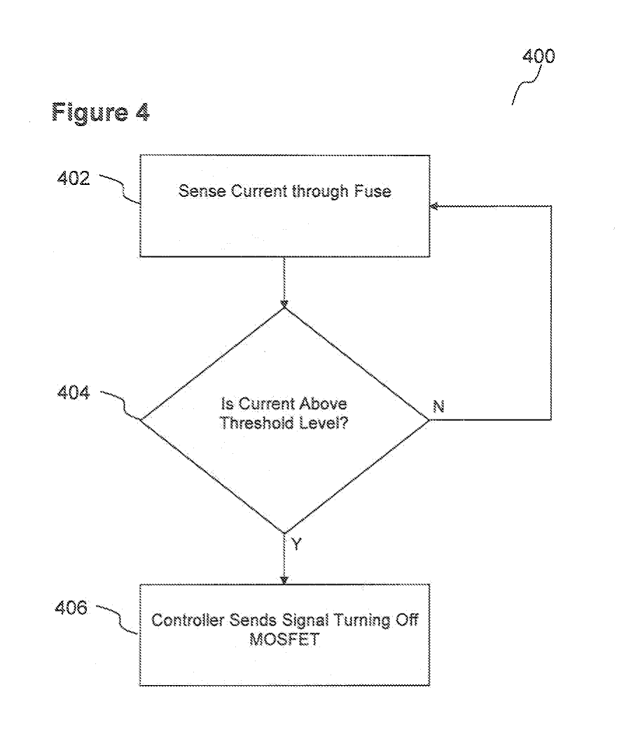

FIG. 4 shows an exemplary flow diagram of a method 400 implemented in accordance with embodiments of the invention. The method comprises, in block 402, sensing the amount of current through fuse 302 from FIG. 3. As stated above, fuse 302 has a resistance associated with it allowing for it to be used as a current sensing device. Method 400 continues in block 404 with controller 312 determining whether the current sensed using fuse 302 is above a predetermined value. If the current is below the predetermined value, then method 400 begins again in block 402 with the sensing of the current through fuse 402. However, if the current is above the predetermined value, controller 312 sends a signal to MOSFET 304 to turn off, as shown in block 406. This stops current from flowing into logic circuit 110, preventing damage.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a transistor;
a passive fuse coupled to the transistor; and
control logic coupled to the passive fuse and the transistor,
wherein the control logic senses a voltage drop across the passive fuse, converts the voltage drop across the passive fuse into a current, and sends a signal to the transistor to turn off if the current sensed by the control logic exceeds a predetermined limit.

2. The system of claim 1, wherein the transistor is a metal-oxide field effect transistor (“MOSFET”).

3. The system of claim 1, wherein the passive fuse is a 20 amp, 32 volt passive fuse.

4. The system of claim 1, wherein the control logic does not turn off the transistor based on a voltage drop across a sense resistor.

5. A system, comprising:
a logic circuit; and
a fuse circuit coupled to the logic circuit,
wherein the fuse circuit comprises a transistor; a passive fuse coupled to the transistor; and control logic which senses a voltage drop across the passive fuse, converts the voltage drop across the passive fuse into a current, and sends a signal to the transistor to turn off if the current sensed by the control logic exceeds a predetermined limit.

6. The system of claim 5, wherein the transistor is a metal-oxide field effect transistor (“MOSFET”).

7. The system of claim 5, wherein the passive fuse is a 20 amp, 32 volt passive fuse.

8. The system of claim 5, wherein the control logic does not turn off the transistor based on a voltage drop across a sense resistor.

9. A system comprising:
means for monitoring a voltage drop across a passive fuse; and
means for turning off a transistor if the voltage drop across the passive fuse equates to a current above a predetermined level.
